(19) United States
(12) Patent Application Publication
(10) Pub. No.: US 2015/0363534 A1
(43) Pub. Date: Dec. 17, 2015

(54) METHOD AND APPARATUS FOR POST-OPC VERIFICATION

(71) Applicant: UNITED MICROELECTRONICS CORPORATION, Hsinchu (TW)

(72) Inventors: Kuo-Hsun HUANG, Taichung City (TW); Hsi-Chang Chang, Taichung City (TW); Chao-Yao Chiang, Hsinchu City (TW); Chien-Hung Chen, Taipei City (TW)

(73) Assignee: UNITED MICROELECTRONICS CORPORATION, Hsinchu (TW)

(21) Appl. No.: 14/301,338

(22) Filed: Jun. 11, 2014

(51) Int. Cl. G06F 17/50

(52) U.S. Cl. CPC G06F 17/5081

(57) ABSTRACT

A method for post-OPC verification including of several steps is provided. First, a pre-OPC layout of an integrated circuit (IC) is received. Then, a first OPC procedure is performed to obtain a post-OPC layout of the IC. After that, a first extraction process is performed on the pre-OPC layout and a second extraction process is performed on the post-OPC layout to respectively obtain a first netlist and a second netlist by using a processor. Next, a verification process is performed by using the processor to determine whether an electrical network of the first netlist and an electrical network of the second netlist are identical. The verification process is then terminated if the electrical network of the first netlist and the electrical network of the second netlist are identical. An apparatus for post-OPC verification is also provided.

### FIELD OF THE INVENTION

The present invention relates to a method and an apparatus for integrated circuit design, and more particularly to a method and an apparatus for post-OPC (optical proximity correction) verification utilized in integrated circuit design.

### BACKGROUND OF THE INVENTION

In the semiconductor integrated circuit (IC) industry, photolithography is the process to use light to transfer circuit patterns to a semiconductor wafer, such as, a silicon or GaAs wafer. However, the photolithography process becomes more challenging when the desired pattern size on wafer becomes smaller and smaller and the features of the pattern become closer and closer to each other.

Besides, due to the limitations of light or process effects, these transferred patterns appear with errors or irregularities such as rounded corners or line widths that are narrower or wider than designed. If these distortions are not corrected, the electrical properties of what was being fabricated may be altered significantly. Therefore, a photolithography enhancement technique such as an optical proximity correction (OPC) procedure is indispensable to compensate for image errors. However, compared to an original design layout as shown in FIG. 1A, some disconnection may still occur within the IC layout resulting from the photolithography enhancement technique, as shown within a dotted circle 10 as shown in FIG. 1B. Thus, it is desirable to develop a method or an apparatus for verification of the IC layout.

### SUMMARY OF THE INVENTION

In accordance with an aspect, the present invention provides a method for post-OPC verification including a plurality of steps. First, a pre-OPC layout of an integrated circuit (IC) is received. Then, a first OPC procedure is performed to obtain a post-OPC layout of the IC. After that, a first extraction process is performed on the pre-OPC layout and a second extraction process is performed on the post-OPC layout to respectively obtain a first netlist and a second netlist by using a processor. Next, a verification process is performed by using the processor to determine whether an electric network of the first netlist and an electric network of the second netlist are identical. The verification process is done if the electric network of the first netlist and the electric network of the second netlist are identical.

In accordance with an aspect, if the electric network of the first netlist and the electric network of the second netlist are different, the method further includes steps of performing a second OPC procedure; repeating the performing the second extraction process after the second OPC procedure is performed; and repeating the performing the verification process.

In accordance with another aspect, the present invention provides an apparatus for post-OPC verification including a processor, a receiving module, and a non-transitory computer-readable storage. The receiving module is communicatively coupled to the processor and configured to receive a pre-OPC layout. The non-transitory computer-readable storage is communicatively coupled to the processor and includes instructions executable by the processor. The instructions include: instructions to perform an OPC procedure to obtain a post-OPC layout; instructions to respectively perform a first extraction process from the pre-OPC layout and a second extraction process from the post-OPC layout to obtain a first netlist and a second netlist; and instructions to perform a verification process to determine whether an electric network of the first netlist and an electric network of the second netlist are identical, wherein the verification process is done if the electric network of the first netlist and the electric network of the second netlist are identical.

In accordance with an aspect, if the electric network of the first netlist and the electric network of the second netlist are different, the instructions further include: instructions to perform a second OPC procedure; instructions to repeat the performing the second extraction process after the second OPC procedure is performed; and instructions to repeat the performing the verification process.

### BRIEF DESCRIPTION OF THE DRAWINGS

The present invention will become more readily apparent to those ordinarily skilled in the art after reviewing the following detailed description and accompanying drawings, in which:

FIGS. 1A and 1B are diagrams schematically showing a typical disconnection that has occurred within the IC layout resulting from photolithography enhancement techniques.

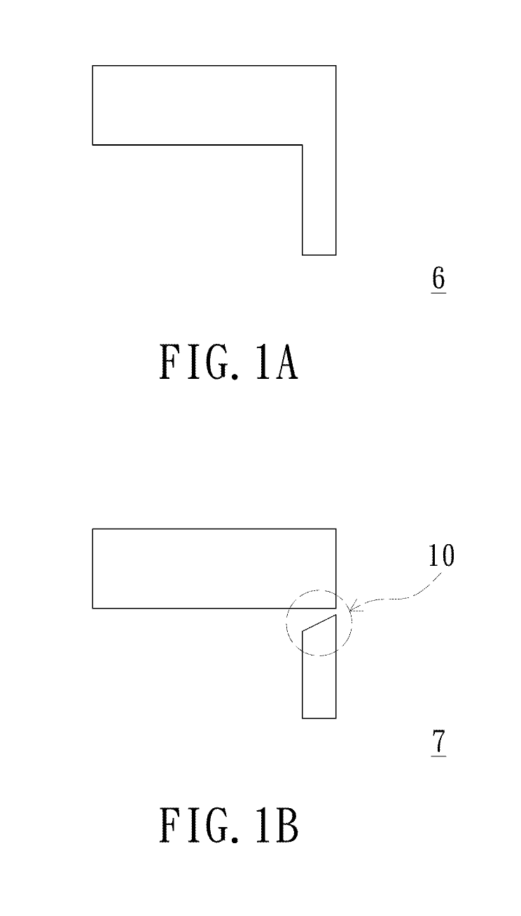

FIG. 2 is a flowchart of an electronic design automation process for IC design.

FIG. 3 is a diagram showing an apparatus for post-OPC verification before photomask fabrication according to one embodiment of the present invention; and

FIG. 4 and FIG. 5 are flowcharts of a method for post-OPC verification before photomask fabrication according to one embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

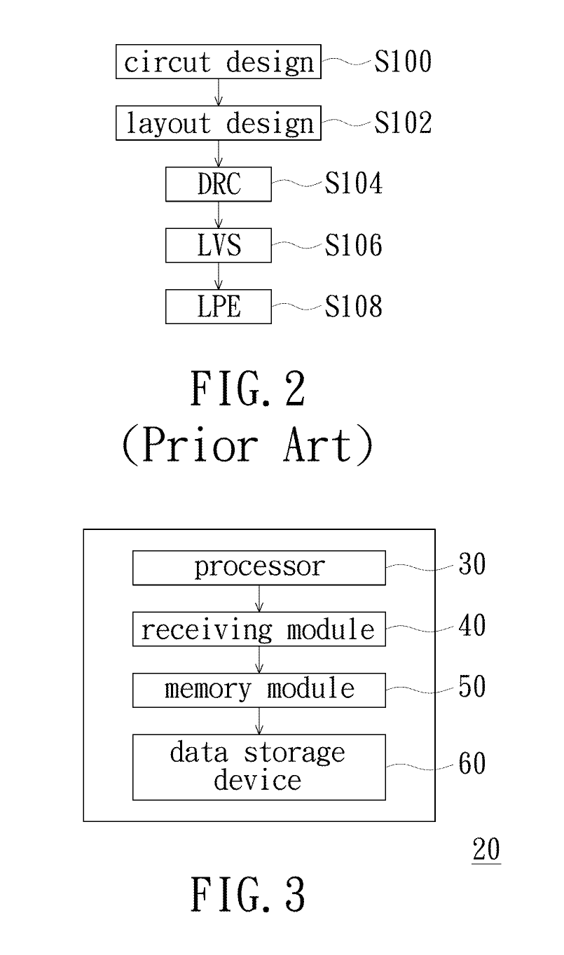

Integrated circuit (IC) design may be undergone an electronic design automation (EDA) process, as shown in FIG. 2. The EDA process begins in Step S100 where an electronic circuit of an IC including of many symbols and nets is being designed in a schematic form. The Step S100 is also known as “front end” design. Besides, the circuit schematic can be converted to a SPICE format netlist. Next, the EDA process proceeds to Step S102 where an original layout including of many shapes and text labels is designed with respect to the IC. In other words, the original layout includes various geometrical patterns representing features of the IC. For example, the original layout may include main features such as an active region, gate electrode, source and drain, metal lines or vias of an interlayer interconnection, and openings for bonding pads. The original layout can be shown as GDSII format or OASIS format. The Step S102 is also known as “back end” design.

The EDA process next proceeds to Step S104, which includes a design rule check (DRC). The DRC determines whether the original layout of the IC satisfies a series of recommended parameters called “design rules” such as topological design rules (TLR) defined by a foundry. Design rules set specify certain geometric and connectivity restrictions to ensure sufficient margins to account for variability in semiconductor manufacturing processes so as to ensure that the parts work correctly. For instance, a width rule specifies the minimum width of any shape in the design; a spacing rule specifies the minimum distance between two adjacent objects. The original layout may be modified if it does not pass the DRC.

Then, the EDA process may proceed to Step S106 as the original layout passes the DRC in Step S104. Step 106 is called a layout versus schematic (LVS) check. A successful DRC ensures that the original layout conforms to the design rules. However, the successful DRC does not guarantee if it really represents the circuit which is desired to fabricate. Thus, the LVS check determines whether the original layout corresponds to the original circuit schematic. A netlist is extracted from the original layout and compared with the netlist taken from the original circuit schematic. The original layout may be modified if it does not pass the LVS check.

As the original layout passes the LVS check, the EDA process next proceeds to Step S108 where layout parasitic extraction (LPE) is performed. LPE includes calculation of the parasitic effects, e.g. parasitic capacitances, parasitic resistances, in both the designed devices and the required wiring interconnects of the electronic circuit. As the designed devices are smaller, RC delay plays a more important role.

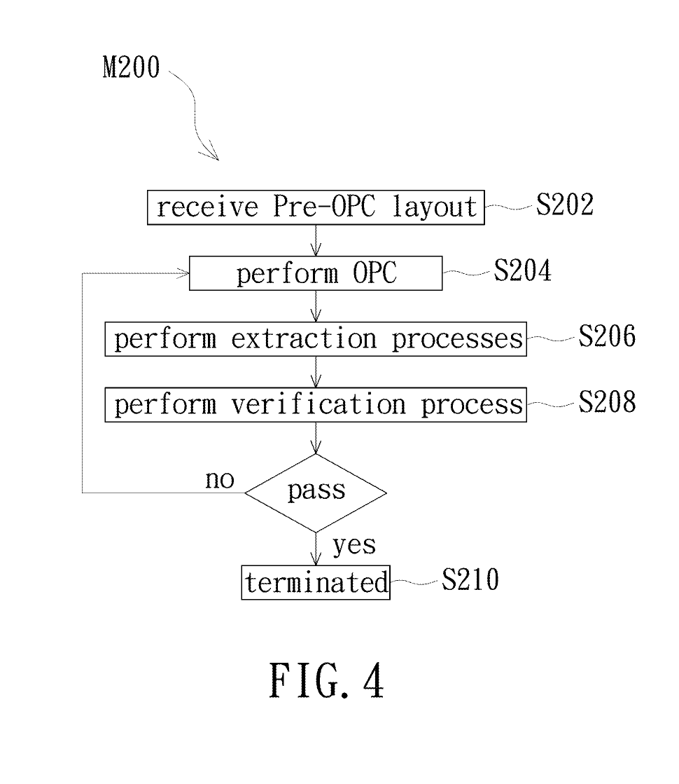

FIG. 3 is a diagram showing an apparatus for post-OPC verification before photomask fabrication according to one embodiment of the present invention. Referring to FIG. 3, an apparatus 20 may be an information processing apparatus, such as a computer, server, or other suitable device. The apparatus 20 includes a processor 30, a receiving module 40, a memory module 50 and a data storage device 60. The processor 30 is communicatively coupled to the receiving module 40, the memory module 50 and the data storage device 60. The receiving module 40 is configured to receive information such as the original layout or the modified layout after the EDA process. The receiving module 40 may be Ethernet cards, cellular data radios, but not limited hereto. The memory module 50 provides the processor 30 with non-transitory computer-readable storage to facilitate execution of computer instructions by the processor 30. The memory module 50 may be a random access memory (RAM) device or a solid state memory device or other memory devices known in the art. The data storage device 60 may store instructions, data, or computer programs. Examples of the data storage device 60 may include but not limit to hard discs, optical discs, solid-state storage devices.

The apparatus 20 is configured to modify the original layout or the modified layout of the circuit, as being called a pre-OPC layout, and to verify a post-OPC layout before photomask fabrication.

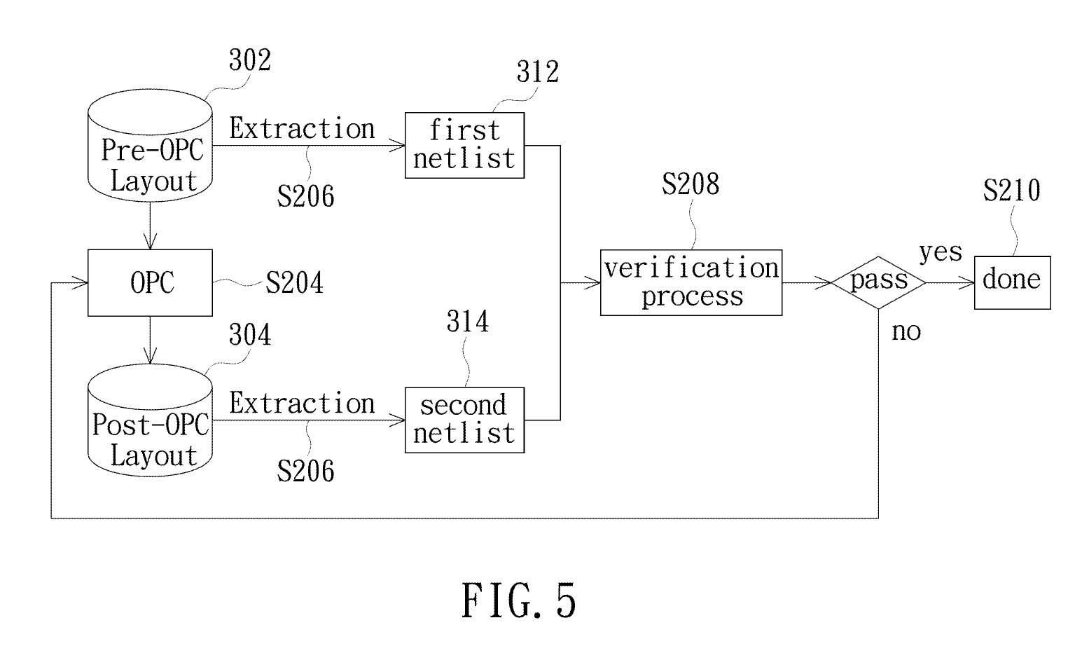

FIG. 4 and FIG. 5 are flowcharts of a method M200 for performing post-OPC verification before photomask fabrication according to one embodiment of the present invention. The method M200 may be implemented by the apparatus 20 shown in FIG. 3. The method M200 begins in Step S202, which includes the receiving module 40 receiving a pre-OPC layout 302 of an IC after the EDA process.

The method M200 next proceeds to Step S204, which includes an OPC procedure performed on the pre-OPC layout 302 of the IC. Specifically, The OPC procedure of Step S204 is the lithography enhancement technique used to compensate for image errors. It may be implemented as model-based or rule-based software instructions executing on the apparatus 20. The OPC procedure may correct these errors by moving edges or adding extra polygons to the pre-OPC layout 302 so as to generate a modified design layout, configured as being a post-OPC layout 304, which is going to be written on photomask. In other words, the OPC procedure is utilized to modify the shape of an IC feature to compensate for diffraction or other process effects so that the shape of the feature as formed in the final integrated circuit closely matches the shape of the feature of the original layout of the IC.

Then, in Step S206, a first extraction process and a second extraction process are performed. In the first extraction process, a first netlist 312 is extracted from the pre-OPC layout 302; and in the second extraction process, a second netlist 314 is extracted from the post-OPC layout 304.

The method M200 next proceeds to Step S208, which includes of a verification process performed to determine whether an electrical network of the first netlist 312 and an electrical network of the second netlist 314 are identical. If no disconnection caused by the OPC procedure (S204) is to be found, the electrical network of the first netlist 312 and the electrical network of the second netlist 314 will be the same. Thus, in comparison with the electrical network of the first netlist 312 and that of the second netlist 314, the verification process can be deemed to be finished or completed if both are determined to be identical (in Step S210).

However, if some disconnection results from the OPC procedure (S204), the first netlist 312 of the pre-OPC layout 302 will be different from the second netlist 314 of the post-OPC layout 304. Thus, in comparison with the electrical network of the first netlist 312 and the electrical network of the second netlist 314, the comparison does not pass the verification process if both are different. Then, the method M200 may return to Step S204, where a second OPC procedure with adjusted parameters corresponding to the disconnection is performed on the pre-OPC layout 302.

After the second OPC procedure is performed, the method M200 proceeds to Steps S206 and S208 again. That is, after a modified post-OPC layout 304 is obtained by the second OPC procedure, another second netlist 314 is extracted from the modified post-OPC layout 304. If an electrical network of an another second netlist 314 is identical to the electrical network of the first netlist 312, the verification process will be deemed finished or completed, so as to be terminated. If the electrical network of the another netlist 314 is still different from the electrical network of the first netlist 312, the method M200 may go back to Step S204 again. Hence, the method M200 may continue proceeding to Steps S204, S206 and S208, respectively, until the comparison between the pre-OPC layout and the post-OPC layout can pass the verification process. Finally, the post-OPC layout passing the verification process may be transferred to photomask fabrication. Consequently, the present invention may ensure the post-OPC layout maintains the electrical properties in accordance with the pre-OPC layout.

It is to be noted that, referring to FIG. 3, the memory module 50, being the non-transitory computer-readable storage, includes various instructions executable by the processor 30, these various instructions stored in the memory module 50 are configured to perform each of the steps, namely Steps S202, S204, S206, S208, and S210, as shown in FIG. 4 and FIG. 5.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method for post-OPC verification, comprising steps of:
receiving a pre-OPC layout of an integrated circuit (IC);
performing a first OPC procedure to obtain a post-OPC layout of said IC;
performing a first extraction process on said pre-OPC layout and a second extraction process on said post-OPC layout to obtain a first netlist and a second netlist by using a processor, respectively; and
performing a verification process by using said processor to determine whether an electrical network of said first netlist and an electrical network of said second netlist are identical, wherein the electrical network of said first netlist is extracted from said pre-OPC layout and said electrical network of said second netlist is extracted from said post-OPC layout, said verification process is terminated if said electrical network of said first netlist and said electrical network of said second netlist are identical.

2. The method according to claim 1, if said electrical network of said first netlist and said electrical network of said second netlist are different, further comprising steps of:
performing a second OPC procedure;
repeating said performing said second extraction process after said second OPC procedure is performed; and
repeating said performing said verification process.

3. An apparatus for post-OPC verification, comprising:
a processor;
a receiving module, communicatively coupled to said processor and configured to receive a pre-OPC layout; and
a non-transitory computer-readable storage, communicatively coupled to said processor and comprising instructions executable by said processor, said instructions comprising:
instructions to perform an OPC procedure to obtain a post-OPC layout;
instructions to respectively perform a first extraction process from said pre-OPC layout and a second extraction process from said post-OPC layout to obtain a first netlist and a second netlist; and
instructions to perform a verification process to determine whether an electrical network of said first netlist and an electrical network of said second netlist are identical, wherein said verification process is terminated if said electrical network of said first netlist and said electrical network of said second netlist are identical.

4. The apparatus according to claim 3, if said first netlist and said second netlist are different, wherein said instructions further comprising:
instructions to perform a second OPC procedure;
instructions to repeat said performing said second extraction process after said second OPC procedure is performed; and
instructions to repeat said performing said verification process.
